(19) United States
(12) Patent Application Publication
(10) Pub. No.: US 2018/0332162 A1
(43) Pub. Date: Nov. 15, 2018

(54) MOBILE APPLICATION FOR PERSONAL SAFETY

(71) Applicant: CanadianMadeFive Holdings Inc., Vancouver (CA)

(72) Inventors: Merideth SCHUTTER, Vancouver (CA); Gabriel BAUMAN, Vancouver (CA); Raduz BENICKY, Vancouver (CA); Lauren PAGAN, Port Coquitlam (CA)

(21) Appl. No.: 15/976,703

(22) Filed: May 10, 2018

Related U.S. Application Data
(60) Provisional application No. 62/504,359, filed on May 10, 2017.

(51) Int. Cl. H04M 1/725; H04W 4/90; H04W 4/029; G08B 25/00; H04W 12/06

(52) U.S. Cl. CPC H04M 1/72538; H04W 4/90; H04M 2242/04; G08B 25/008; H04W 12/06; H04W 4/029

(57) ABSTRACT

Systems and methods for alerting an emergency contact are provided. The systems and methods are performed on an electronic device which collects, in real-time, data related to a user's personal safety and transmits the data to the user's emergency contact(s). The systems and methods include creating a timer mode having a start time and an end time, assigning an emergency contact to the timer mode, at the start time of the timer mode automatically activating the timer mode, at the end time of the timer mode automatically activating an emergency mode, and communicating the user's personal safety data with the emergency contact during the emergency mode. To create the timer mode or assign the emergency contact(s), information from the user's electronic device and/or on a remote server may be imported.

### TECHNICAL FIELD

The present invention is in the field of personal safety. Particular embodiments relate to systems and methods for alerting emergency contact(s) and/or emergency personnel if a user's personal safety is potentially compromised.

### BACKGROUND

Personal safety is crucial. Often informed precautions can be taken and potential risks can be avoided. However, the risk of crime, natural disaster, or bodily injury is pervasive and not always easily evaded. For example, activities including studying at university, online dating, working late, taking public transportation, babysitting, and real estate brokering bring individuals into contact with new acquaintances where they may feel less secure and/or are exposed to potential risks. Individuals also engage in hobbies, such as running in the park, road trips, and engaging in adventure sports, that carry danger and risk. Whether a person is the victim of a crime, a natural disaster, or suffers an injury, the events that transpire following the tragedy are generally the most important to rescue efforts.

Many individuals carry portable electronic devices, such as smart phones and tablets, that are capable of transmitting information relevant to a person's safety. For example, such devices are often equipped with a Global Positioning System (GPS) for determining the location of the device, a microphone to record audio, a camera to record digital images and video, and wireless connection for transmitting information, including GPS coordinates, audio, and digital images and video, via the Internet and satellites.

Portable electronic devices are playing an increasing role in emergency response and rescue efforts and mobile software applications related to personal safety have been developed. However, such applications are typically limited. For example, many of these applications merely act as distress beacons, which transmit information to an emergency contact and/or emergency response personnel when a device user manually triggers an alarm. Applications which allow users to set a timer that counts down and triggers the alarm automatically have also been developed. However, these applications require users to manually set and start a timer for an activity that exposes the user to risk and/or restrict a user's ability to contact the most appropriate emergency contacts and/or emergency personnel in the event of an emergency, making these applications impractical and inadequate for daily and ongoing use.

There is a general desire for practical and more effective software applications and methods of prompting emergency response efforts.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The systems and methods provided herein address the needs of users and provide improvements over existing personal safety mobile applications and security systems. The systems and methods provided herein collect, in real-time, data related to a user's personal safety and transmit the collected data to the user's emergency contact(s) and/or emergency response personnel. In some embodiments, the systems and methods, via a graphical user interface shown on a display, allow a user to create multiple events that each independently activate a timer mode. The multiple events may be imported by the user from a calendar stored on the user's electronic device and/or stored on a remote computer or server. The user assigns one or more emergency contacts and/or emergency personnel to each event, wherein the emergency contact(s) and/or the emergency personnel are contacted with the user's personal safety data if an emergency mode is activated. When more than one emergency contact and/or emergency personnel is assigned, the user may rank the contacts/personnel according to the user's preferred order for transmitting the user's real-time personal safety data if an emergency mode is activated. An emergency mode triggers transmission of the user's real-time personal safety data to one or more emergency contacts and/or emergency personnel, wherein the data includes one or more of the geographic location of the user's electronic device, audio, digital images, video, and the user's profile stored in the user's electronic device and/or on a remote computer or server.

The user may end a timer mode and/or deactivate an emergency mode by entering the user's predetermined identification key (e.g. a fingerprint identity or a personal identification number (PIN)).

One aspect of the invention provides a method performed on an electronic device for overseeing the personal safety of a user. The method includes creating a timer mode having a start time and an end time, assigning an emergency contact to the timer mode, at the start time of the timer mode automatically activating the timer mode, at the end time of the timer mode automatically activating an emergency mode, and communicating the user's personal safety data with the emergency contact during the emergency mode.

In some embodiments, creating the timer mode includes importing a calendar event stored locally on the electronic device and/or on a remote server and/or on the user's social media or other communication platform.

In some embodiments, assigning an emergency contact to the timer mode includes importing contact information of the emergency contact stored locally on the electronic device and/or on a remote server and/or on the user's social media or other communication platform.

In some embodiments, assigning an emergency contact to the timer mode includes assigning a predetermined number of emergency contacts to the timer mode.

In some embodiments, assigning the emergency contact to the timer mode includes assigning one or more emergency contacts to a group and assigning the group to the timer mode.

In some embodiments, the method includes assigning priority to the emergency contacts within the group, wherein the emergency contact having a first priority is first communicated the user's personal safety data and each emergency contact having a subsequent priority is subsequently communicated the user's personal safety data.

In some embodiments, the method includes determining an amount of time between communicating the user's personal safety data with each emergency contact according to the assigned priority of each emergency contact.

In some embodiment, the emergency mode is automatically activated only if the user has not dismissed or delayed the end time.

In some embodiments, the method includes entering a first user identification key to deactivate the emergency mode. In some embodiments, the first user identification key is a personal identification number, a biometric (e.g. a fingerprint), a password, or a correct answer to a personal security question.

In some embodiments, the method includes entering a second user identification key to activate the emergency mode. In some embodiments, the second user identification key is a personal identification number, a biometric (e.g. a fingerprint), a password, or a correct answer to a personal security question.

In some embodiment, the method includes recording one or more of global positioning system (GPS) data, audio data, video data, and a digital image on activation of the emergency mode.

In some embodiments, the method includes recording one or more of GPS data, audio data, video data, and a digital image at predetermined time intervals on activation of the emergency mode.

In some embodiments, the user's personal safety data comprises one or more of GPS data, audio data, video data, and a digital image.

In some embodiments, the method includes entering a low power mode to save battery power of the electronic device when the battery power of the electronic device is below a predetermined limit during the timer mode.

In some embodiments, assigning an emergency contact to the timer mode requires the emergency contact to agree to receive the user's personal safety data on activation of the emergency mode.

In some embodiments, the method includes deactivating the time mode, wherein deactivating the timer mode avoids communicating the user's personal safety data to the emergency contact. In some embodiments, the user's personal safety data is deleted on deactivating the timer mode.

In some embodiments, the user's personal safety data is stored on the electronic device and/or on a remote server.

In some embodiments, the method includes notifying the user when the end time of the timer mode is within a predetermined amount of time.

In some embodiments, the method includes extending the end time of the timer mode.

In some embodiments, the user's personal safety data is communicated to the emergency contact during the timer mode.

In some embodiments, communicating the user's personal safety data to the emergency contact comprises providing the emergency contact with access to an activity portal. In some embodiments, the activity portal comprises a webpage including the user's personal safety data and/or the contact information of the emergency contact. In some embodiments, the emergency contact can communicate with other emergency contacts via the activity portal.

In some embodiments, the emergency contact can communicate with other emergency contacts via the activity portal.

In some embodiments, the method includes notifying the user if cellular reception and/or internet connectivity of the electronic device is lost.

In some embodiments, the method includes recording one or more of GPS data, audio data, video data, and a digital image when an incorrect personal identification key is entered during the emergency mode and/or the timer mode.

In some embodiments, the method includes transmitting a fake call at a call time predetermined by the user.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows a personal safety system according to an example embodiment of the present invention.

FIG. 2 shows an electronic device on which is installed a mobile application according to an example embodiment.

FIG. 3 shows a flowchart of setup of the mobile application according to an example embodiment.

FIG. 4 shows a flowchart of operation of the mobile application shown in FIG. 2.

FIGS. 5 to 28 show various screenshots of the mobile application user interface according to example embodiments as provided on a user's electronic device or an emergency contact or personnel's electronic device.

### DESCRIPTION

The detailed description of exemplary embodiments herein makes reference to the accompanying drawings and pictures, which show the exemplary embodiments by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for the purposes of illustration only and not of limitation. For example, the steps recited in any of the methods or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems and methods described herein may be used for personal safety applications. Embodiments disclosed herein involve the combination of: (i) collecting, in real-time, data related to a user's personal safety; and (ii) transmitting the collected data to the user's emergency contact(s) and/or emergency response personnel.

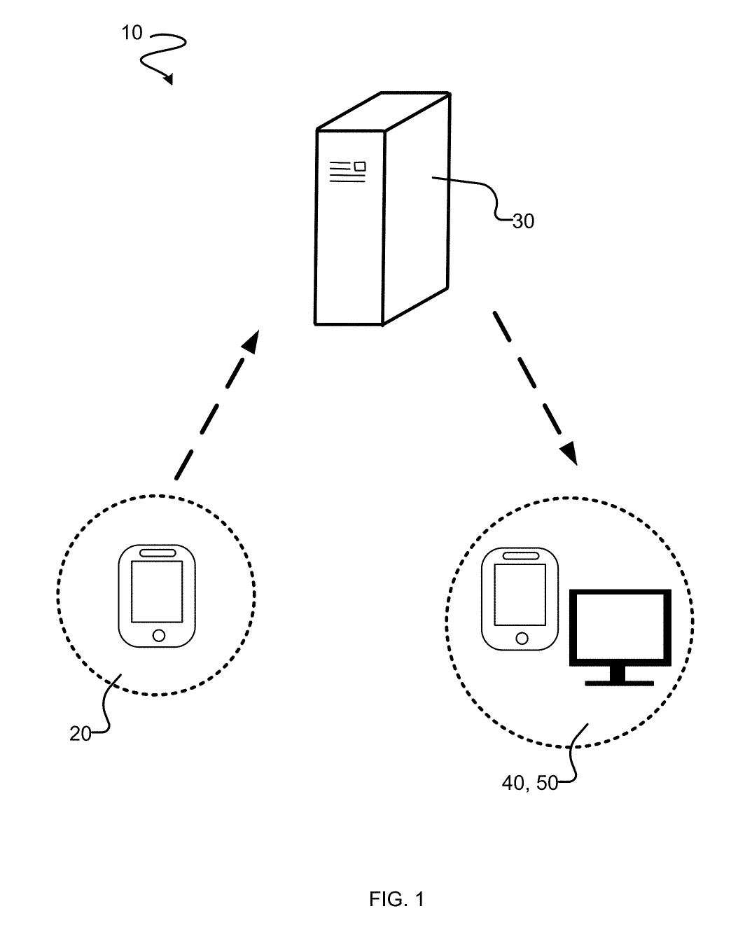

FIG. 1 illustrates an example embodiment of a personal safety system 10. As shown in FIG. 1, personal safety system 10 includes an electronic device 20 in communication with a system server 30. System server 30 is in further communication with one or more electronic devices 40, each device 40 operated by an emergency contact, and/or one or more electronic devices 50, each device 50 operated by an emergency personnel. Unless context dictates otherwise, the term “emergency contact” (as used herein) refers to a user defined contact that is contacted in the event that an emergency mode is activated. Unless context dictates otherwise, the term “emergency personnel” (as used herein) refers to an emergency authority associated with the geographic location of the user's electronic device and/or defined by the user. For example, emergency personnel may include a 911 Command Center and their associated emergency services (e.g. police, fire, and emergency medical services). In some embodiments, emergency personnel includes Search and Rescue authorities associated with the geographic location of the user's electronic device. In the event that an emergency mode is activated by electronic device 20, system server 30 communicates with electronic device(s) 40 and/or 50 to provide information related to the personal safety of the user of electronic device 20 to emergency contacts and/or emergency personnel. In some embodiments, as further described elsewhere herein, in the event that an emergency mode is activated, system server 30 provides electronic device(s) 40 and/or 50 with a link to an activity portal containing information related to the personal safety of the user.

In some embodiments, one or more electronic devices 20, 40, and 50 may be in one-way communication with system server 30 (e.g. syncing setup information, communicating emergency modes). In other embodiments, one or more electronic devices 20, 40, and 50 may be in two-way communication with system server 30 (e.g. syncing setup information/communicating emergency modes as well as confirming receipt of information received by system server 30). While shown and described as a singular system server 30, persons skilled in the art will recognize that system server 30 may be any number of system servers 30 adapted to support the necessary data management and server functions to support various features and functions of personal safety system 10 described herein. System server 30 may be a suitable web server capable of receiving data from one or more electronic devices 20, 40, and 50 over a cellular data network. Further, persons skilled in the art will understand that system server 30 may receive data from one or more electronic devices 20, 40, and 50 over one or more networks which may include other types of networks such as satellite data networks, WiFi networks, and the like.

Electronic devices 20, 40, and 50 are any portable device that enables collecting and transmitting data related to the personal safety of the user as described elsewhere herein.

For example, electronic devices 20, 40, and 50 may comprise a smartphone, a tablet computer, a personal navigation device, a digital camera, or a smartwatch. Electronic devices 20, 40, and 50 may include one or more of a Global Positioning System (“GPS”) for determining the device's geolocation, a microphone for recording audio, a camera for recording digital images and/or video, and a wireless connection for transmitting information (e.g. data) via the Internet and/or satellites.

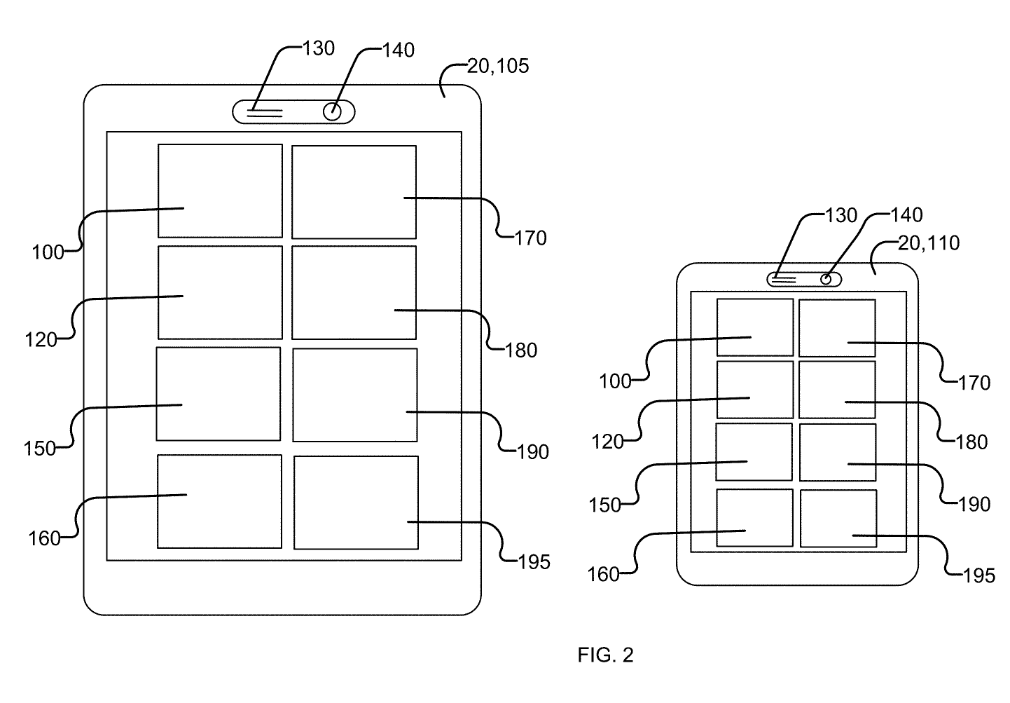

Turning to FIG. 2, electronic device 20 is shown in more detail. Electronic device 20 is any portable device that enables collecting and transmitting data related to the personal safety of the user as described elsewhere herein. For example, electronic device 20 may comprise a smartphone (e.g. smartphone 110), a tablet computer (e.g. tablet computer 105), a personal navigation device, a digital camera, or a smartwatch. A mobile application 100 is installed in a memory location on electronic device 20.

Mobile application 100 may be configured to be executed on any of a variety of electronic devices described elsewhere herein, for example, a tablet 105 and/or a smartphone 110. Mobile application 100 may be configured to utilize varying display configurations (e.g. resolution, screen dimensions, fonts, graphics, etc.) based on the type of electronic device being used. For example, when mobile application 100 is downloaded and/or used on tablet 105, additional, larger, or more detailed graphical elements, increased display resolution, and/or larger screen dimensions may be used for displaying mobile application 100 due to the larger screen size of tablet 105 when compared against other devices, such as smartphone 110.

Mobile application 100 is configured to collect various data regarding a user's personal safety, as discussed in greater detail elsewhere herein. Mobile application 100 may utilize both graphical information and/or audible information to interact with the user. In certain embodiments, mobile application 100 may additionally or alternatively utilize tactile information to interact with the user (e.g. vibration of the electronic device). Mobile application 100 may interface with a database, stored locally and/or on a remote server, that is configured to store one or more user accounts or profiles. If the database is stored remotely, a user may have access to the account or profile stored in the database and can apply various configurations or settings for mobile application 100 regardless of the electronic device used in executing mobile application 100. In some embodiments, mobile application 100 will be configured to operate in a low power mode wherein, for example, a screen or display of the electronic device is turned off in order to save battery power of the electronic device. Since the user may not be in a position to recharge a battery of the electronic device while using the electronic device during an activity that exposes the user to risk, efficient management of battery power by the mobile application would be maintained by the low power mode and/or by other battery saving features (e.g. disabling certain graphical effects when the battery level goes below a predetermined threshold).

Mobile application 100 is configured to collect, in real-time, data related to a user's personal safety. For example, if the mobile application is being executed on an electronic device capable of determining geographic positioning, such as through the use of a GPS, particular pieces of information may be collected that are relevant to such geographic positioning. Other manners of collecting data related to a user's personal safety may be utilized. For example, if the electronic device has a camera or other image capture component or components, digital images and/or video may be collected. If the electronic device has a microphone, audio may be collected. Mobile application 100 may interface with a database, stored locally and/or on a remote server, that is configured to store one or more GPS data, video, and audio. If the database is stored remotely, a user may have access to one or more of the GPS data, video, and audio stored in the database and can apply various configurations or settings for mobile application 100 regardless of the electronic device used in executing mobile application 100.

In the example embodiment shown in FIG. 2, electronic device 20 includes a GPS 120 for determining the device's geo-location, a microphone 130 for recording audio, and a camera 140 for recording digital images and/or video. Mobile application 100 uses one or more of GPS 120, microphone 130, and camera 140 to acquire data related to a user's personal safety. Mobile application 100 may interface with a database, stored locally and/or on a remote server, that is configured to store one or more of GPS coordinates 150, audio data 160, digital images 170, and video data 180 acquired via electronic device 20. Mobile application 100 may interface with a database, stored locally and/or on a remote server, that is configured to store one or more of a user's calendar 190, or other system for organizing the user's events, and a user's contact information 195, including contact information for the emergency contact(s) and/or the emergency personnel. One or more of acquired GPS coordinates 150, audio data 160, digital images 170, and video data 180 may be transmitted to the user's emergency contact(s) and/or emergency personnel by system server 30 using contact information 195. In some embodiments, the database is configured to store or automatically delete GPS coordinates 150, audio data 160, digital images 170, and video data 180 acquired via electronic device 20.

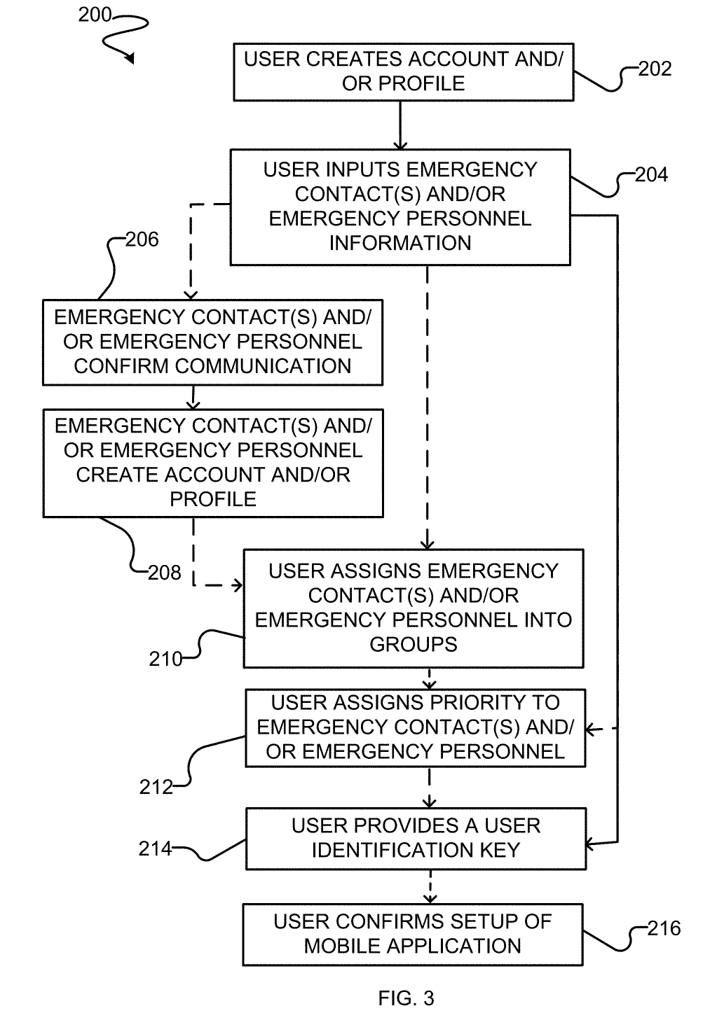

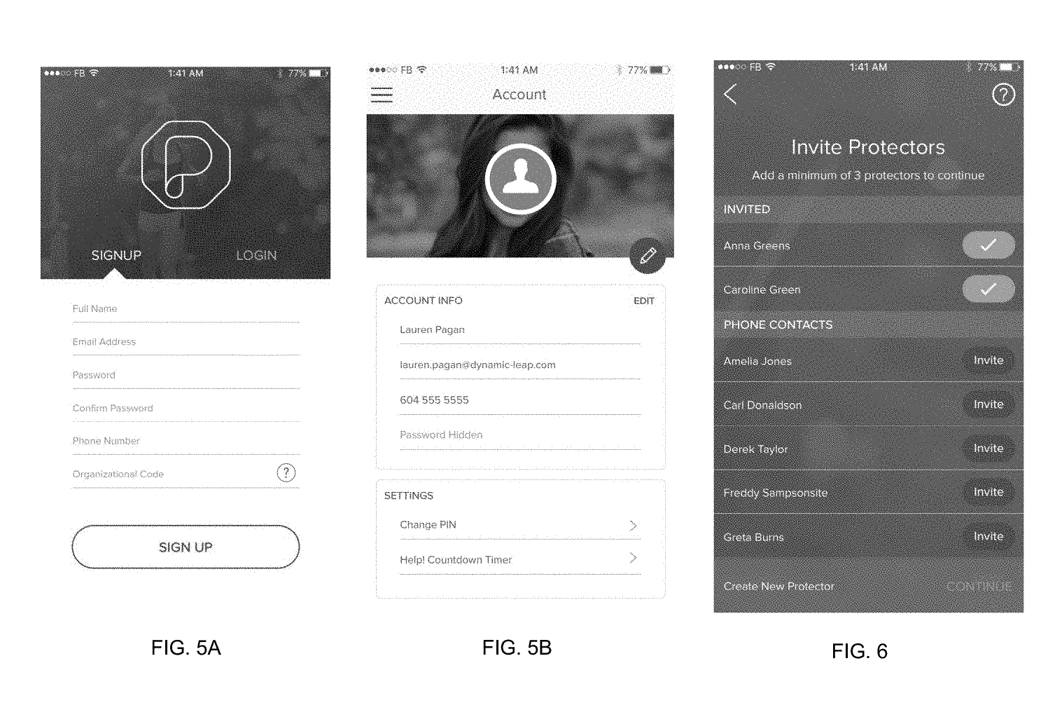

FIG. 3 shows a method 200 of setting up mobile application 100. At step 202, a user creates a user account and/or a profile. For example, as shown in the FIG. 5A example screenshot, the user may be required to provide personal information (e.g. one or more of first name, last name, physical address, email address, password, telephone number, age, height, weight, hair colour, eye colour, etc.). This information may be provided to the user's emergency contact(s) (via electronic device 40) and/or emergency personnel (via electronic device 50) if an emergency mode is activated. In some embodiments, the user can create a user account and/or profile using one or more of the user's social media accounts (e.g. Facebook, Gmail, etc.). The user may change its user account and/or profile information at any time. The FIG. 5B example screenshot shows a user's account information and settings for application 100, FIGS. 5A and 5B are collectively referred to herein as FIG. 5.

At step 204, mobile application 100 prompts the user to input contact information for one or more emergency contacts and/or emergency personnel to be automatically contacted when an emergency mode is activated. In some embodiment, mobile application 100 requires the user to input contact information for a minimum number of contacts and/or emergency personnel (e.g. three emergency contacts and/or emergency personnel) to be contacted when an emergency mode is activated. The user may import the contact information for each emergency contact and/or emergency personnel from an address book or other contact information database stored on the user's electronic device and/or on a remote computer or server and/or a social media or other communication platform (e.g. Facebook, Gmail, LinkedIn, etc.). For example, the user may permit mobile application 100 to access the user's contact information 195 stored locally in a database of electronic device 20 and/or on a remote server. The user may permit mobile application 100 to access one or more of the user's social media accounts and import the user's contact information associated with the account(s). In some embodiments, at step 204, the user selects one or more emergency contacts and/or emergency personnel whose contact information has been uploaded. FIG. 6 shows an example screenshot of mobile application 100 allowing a user to invite one or more emergency contacts to agree to communicate with mobile application 100 via system server 30 (as described elsewhere herein).

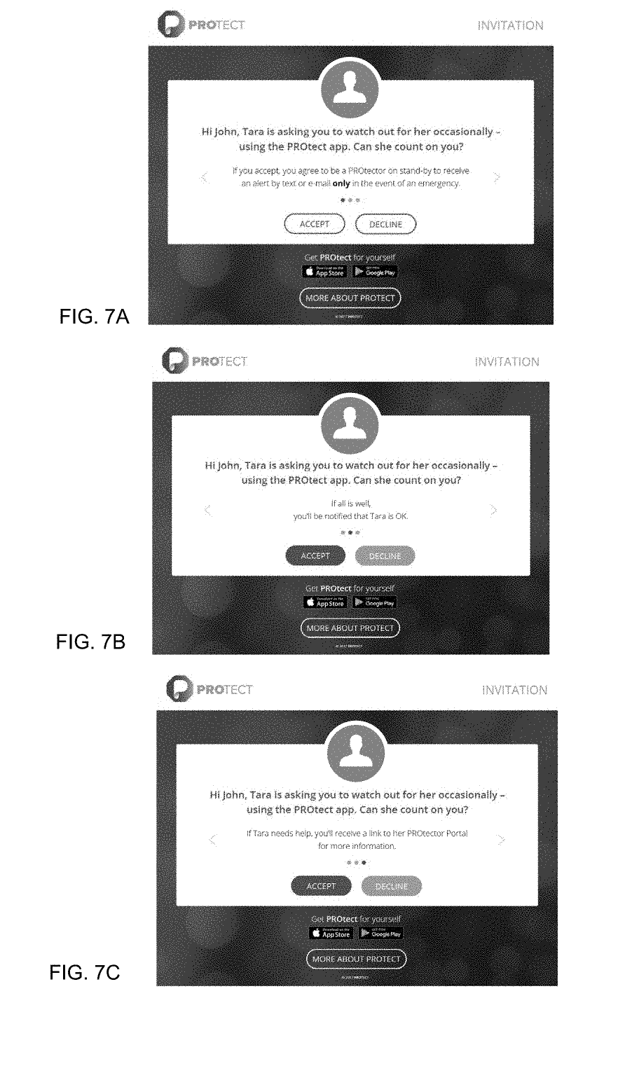

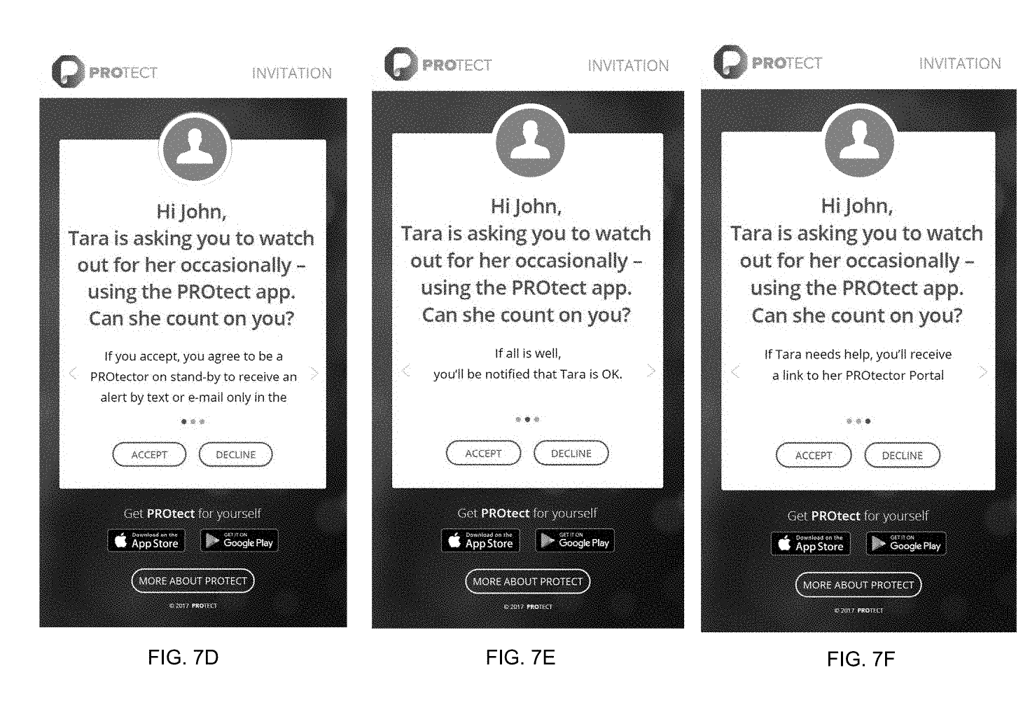

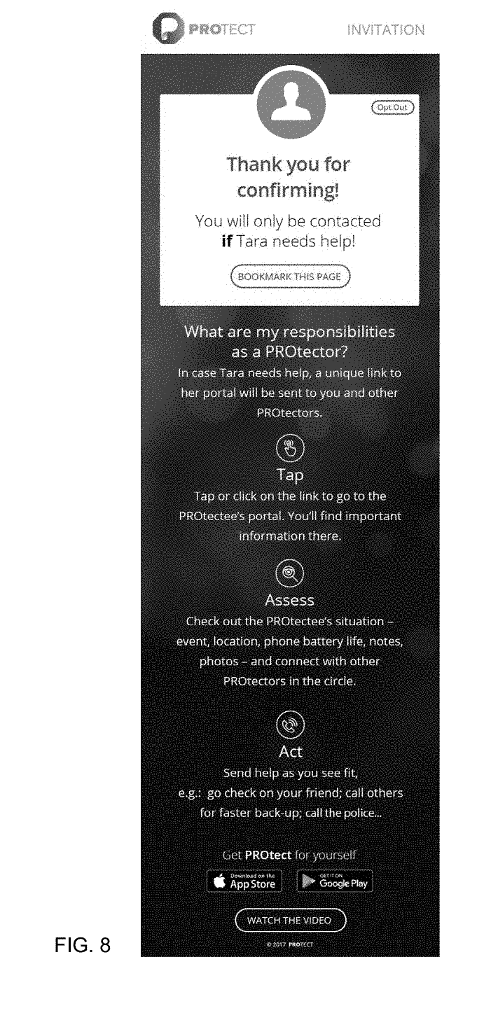

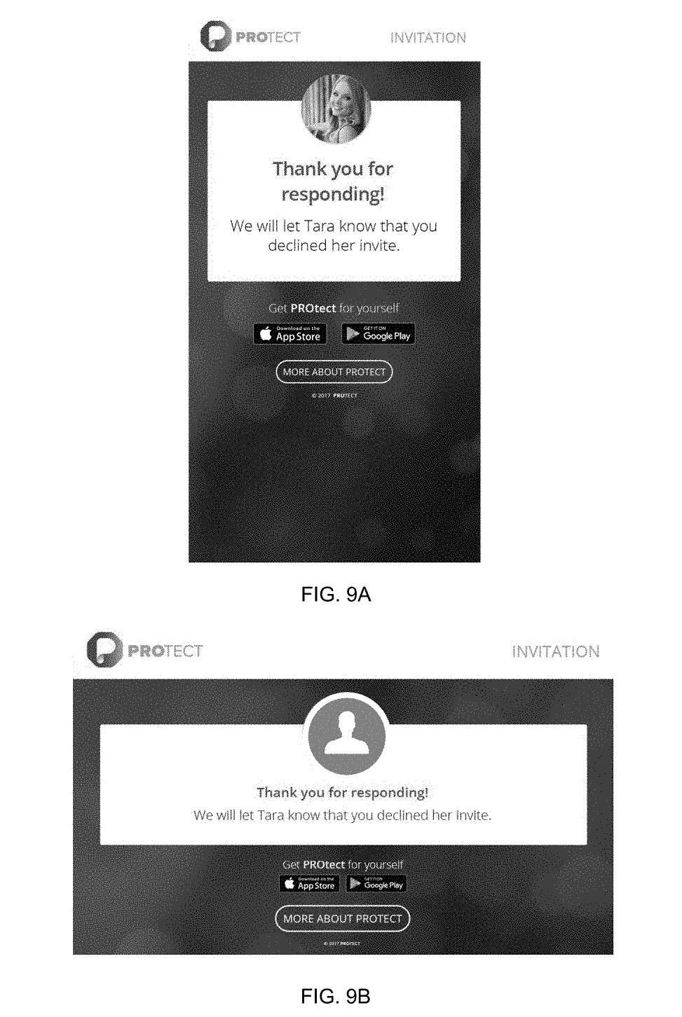

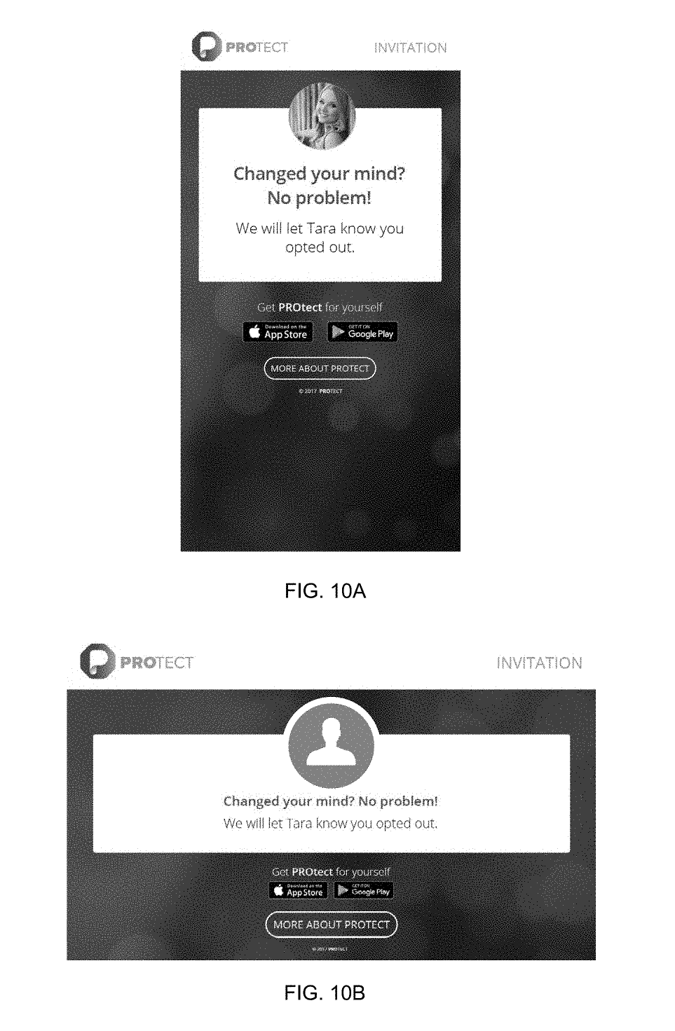

At step 206, mobile application 100 sends each emergency contact (via electronic device 40) and/or each emergency personnel (via electronic device 50) a message (e.g. email, text, or SMS) to confirm the contact's/personnel's approved participation. In some embodiments, mobile application 100 communicates with the assigned emergency contact(s)/personnel via mobile application 100 stored on or accessed by electronic device 40, 50 operated by the corresponding emergency contact(s)/personnel. FIGS. 7A-7F show example screenshots prompting an emergency contact to agree (or decline to agree) to agree to communicate with mobile application 100 via system server 30 (as described elsewhere herein). FIG. 8 shows an example screenshot of mobile application 100 confirming that an emergency contact has agreed to communicate with mobile application 100 via system server 30 and notifying the emergency contact that mobile application 100 will only communicate with the emergency contact via system server 30 if an emergency mode is activated, FIGS. 9A-9B show example screenshots confirming that an emergency contact has declined to communicate with mobile application 100 via system server 30 and notifying the emergency contact that mobile application 100 will notify the user (via system server 30) that the emergency contact has declined communication. The emergency contact(s)/personnel may opt out of communicating with mobile application (via system server 30) at any time. FIGS. 10A and 10B (collectively, FIG. 10) show example screenshots of mobile application 100 confirming that an emergency contact has opted out of communicating with mobile application 100 (via system server 30) and notifying the emergency contact that mobile application 100 will notify the user that the emergency contacted has opted out (via system server 30).

At optional step 208, mobile application 100 may require each emergency contact and/or each emergency personnel to create an account and/or a profile. The emergency contact(s) and/or the emergency personnel may be required to provide an email address, a telephone number, and/or a physical address. The emergency contact(s)/personnel may change corresponding account and/or profile information at any time.

At step 210, mobile application 100 may require the user to assign the emergency contact(s) and/or the emergency personnel into groups. A particular group may be selected to monitor an event that may expose the user to risk (i.e. a timer mode (as described elsewhere herein)). For example, the user may desire different emergency contact(s) and/or emergency personnel to monitor different types of events (e.g. personal or social events vs. work-related events). In some embodiments, the user can assign one or more groups to monitor an event (as described elsewhere herein).

At optional step 212, the user may rank the emergency contact(s)/emergency personnel assigned at step 204 and/or the groups assigned at step 210 according to the order that the user prefers that each emergency contact/personnel be communicated with in the event that an emergency mode is activated. For example, the user may select a ‘primary’ emergency contact(s)/personnel and/or group(s). Mobile application 100 first communicates with the ‘primary’ when an emergency mode is activated. The ‘primary’ may be the user's most reliable emergency contact(s)/personnel for responding to an emergency mode. The user may determine the order that each emergency contact/personnel and/or group is subsequently contacted after the ‘primary’. For example, the user may assign a ‘back-up’ emergency contact(s)/personnel and/or group(s). Mobile application 100 communicates with the ‘back-up’ if none of the user's primary emergency contact(s)/personnel and/or group(s) respond (i.e. communicate with mobile application 100). The user may assign one or more additional back-ups or one or more ‘just-in-case’ emergency contacts/personnel and/or groups. Mobile application 100 communicates with each ‘just-in-case’ if none of the user's ‘back-ups’ respond (i.e. communicate with mobile application 100). In some embodiments, at optional step 212, the user chooses an amount of time that must elapse after an emergency contact/personnel and/or group is contacted before mobile application 100 communicates with the next emergency contact/personnel.

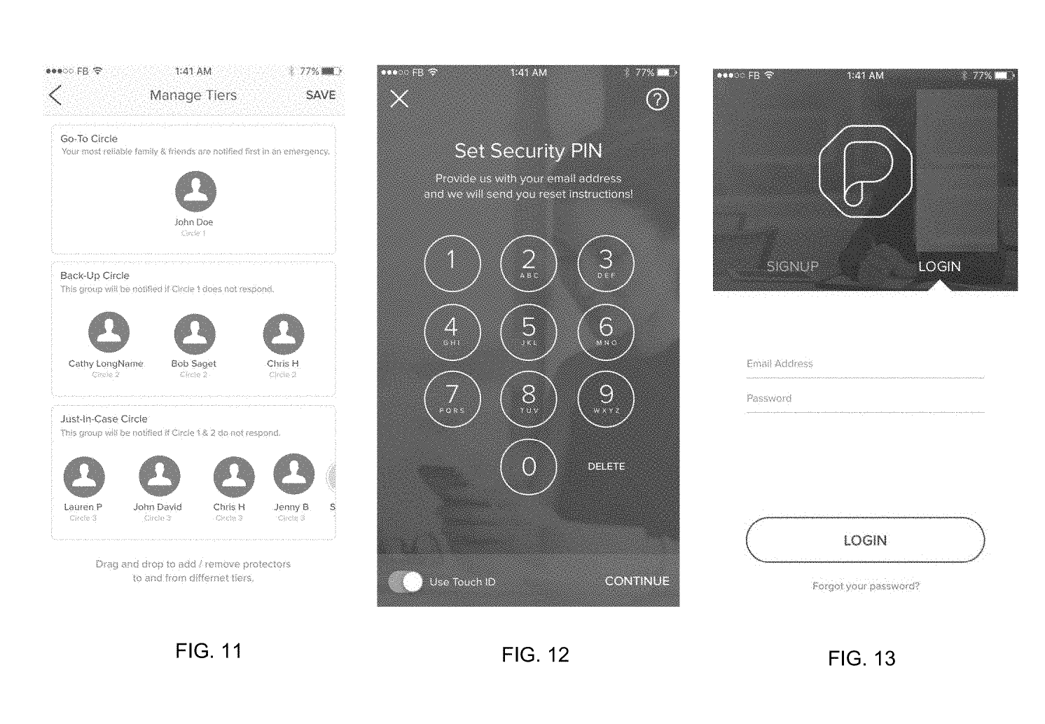

FIG. 11 shows an example screenshot of mobile application 100 prompting the user to assign the user's emergency contact(s)/personnel into groups and assign priority to the emergency contact(s)/personnel and groups according to the order that the user prefers each emergency contact(s)/personnel and/or group to be contacted in the event that an emergency mode is activated.

At step 214, mobile application 100 prompts the user to set a user identification key. FIG. 12 shows an example screenshot of mobile application 100 prompting the user to set a provider identification number (PIN). The user identification key may be used to activate and/or deactivate an emergency mode. The user identification key may include, but is not limited to, one or more of a PIN, a biometric (e.g. a fingerprint identity), a password, and a correct answer to a personal security question. Persons skilled in the art will recognize that other means for identifying the identity of the user using the user's electronic device may be used. In some embodiments, mobile application 100 requires only one user identification key. However, certain embodiments of mobile application 100 may require a greater number of user identification keys for increased functionality. For example, multiple PINs may be used to activate and deactive an emergency mode. The user may provide a first PIN that, when entered into the user's electronic device, activates an emergency mode. A second PIN may be entered to deactivate the emergency mode. In some embodiments, if a user forgets one or more PINs, the user may provide mobile application 100 with, for example, the user's email address and/or an account/profile password. Mobile application 100 may send an email to the user's email address with instructions for resetting the PIN. For example, the email may provide the user with a link that will redirect the user to a website to provide and/or confirm a new PIN.

At the end of setup method 200, mobile application 100 may require the user to confirm that mobile application 100 is communicating with the emergency contact(s) and/or emergency personnel at step 216. Step 216 may further require the user to confirm the setup of mobile application 100 and/or the transmission of user data to system server 30 by, for example, sending a test emergency mode signal to system server 30.

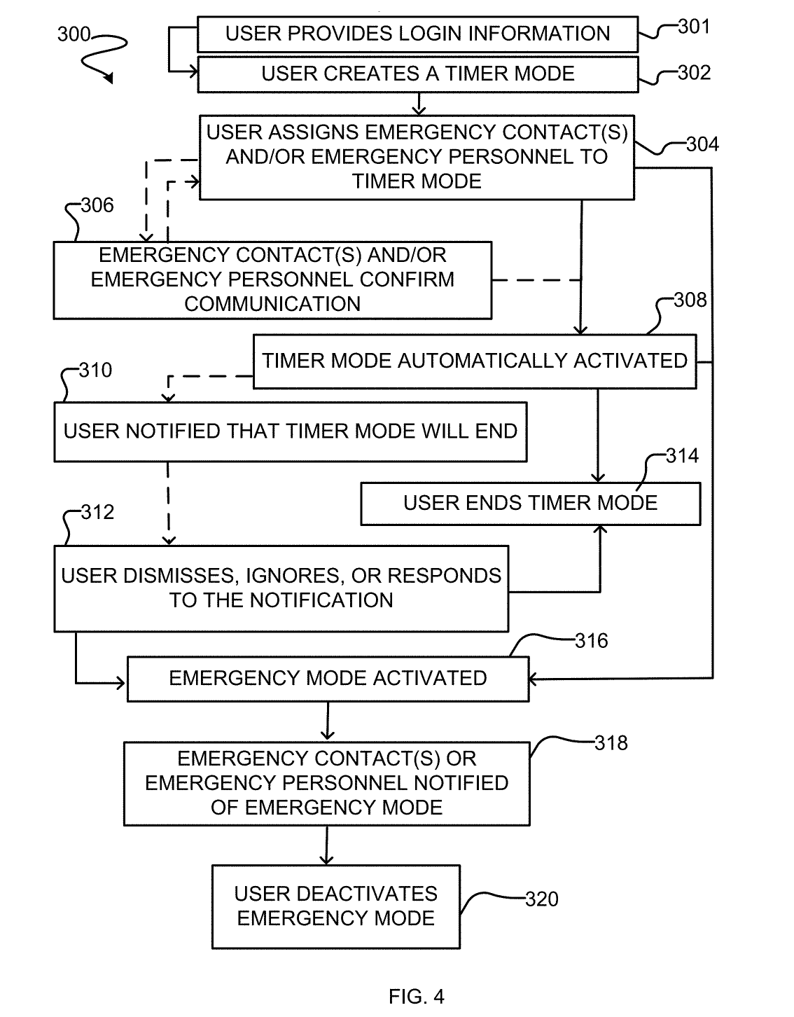

Turning now to FIG. 4, a method 300 of operating mobile application 100 is shown. At step 301, the user provides login information (e.g. an email address and/or a password associated with the user's account and/profile created at step 202). FIG. 13 shows an example screenshot of mobile application 100 prompting a user to provide the user's login information.

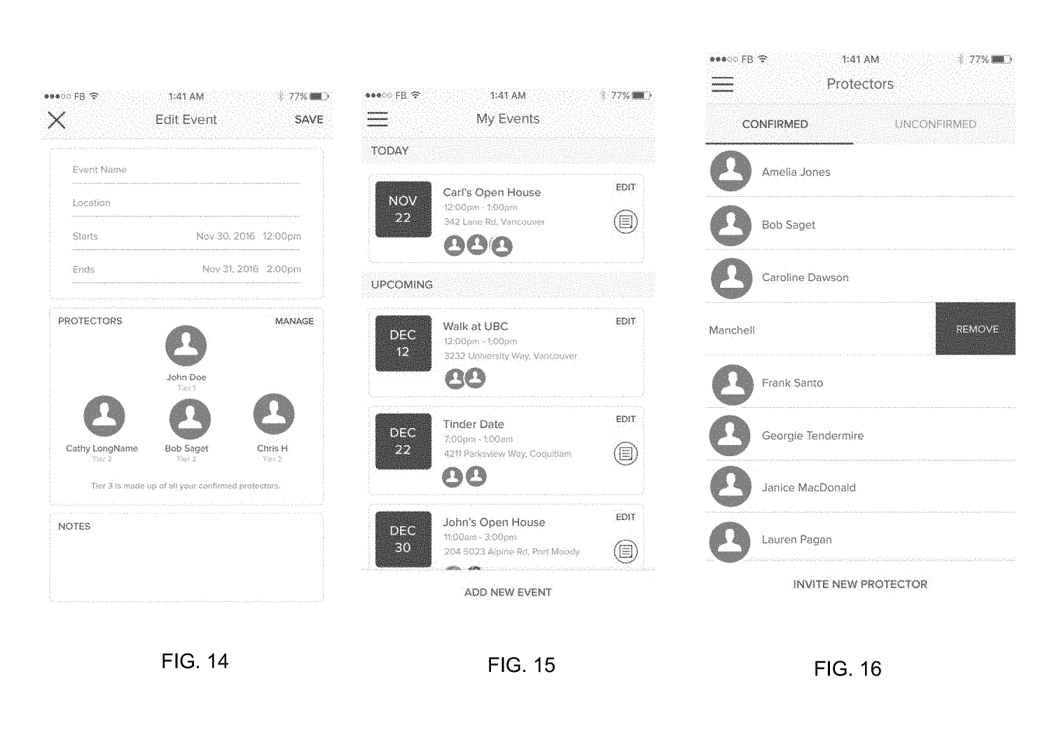

At step 302, the user creates a timer mode for an event that may expose the user to risk. The timer mode may include a start time and an end time. Unless context dictates otherwise, the term “time” (as used herein) refers to a particular day and time of day (e.g. Apr. 27, 2017, at 1700/5:00 pm in the user's time zone or a predefined time zone). In some embodiments, the timer mode includes details about the event (e.g. an event name and/or an event location and/or event notes). FIG. 14 shows an example screenshot of mobile application 100 prompting a user to provide/edit timer mode information. In the example screenshot, the user has input a start time of Nov. 30, 2016 at 12:00 pm and an end time of Nov. 31, 2016 at 2:00 pm for an event. The user may create multiple timer modes at step 302. For example, the user can create a timer mode for multiple events. FIG. 15 shows an example screenshot of mobile application 100 displaying a user's upcoming multiple timer modes. The user selects a start time and an end time for each timer mode. In some embodiments, at step 302, the user can import one or more events from a calendar stored on the user's electronic device and/or stored on a remote computer or server to create one or more timer modes. For example, the user may permit mobile application 100 to access the user's calendar 190 stored locally in a database of electronic device 20 and/or on a remote server, in some embodiments, the user can import one or more events from a calendar stored on the user's social media or other communications platforms (e.g. Facebook, Gmail, etc.). The user may edit the timer mode(s) created at step 302 at any time. In some embodiments, the user can indicate the degree of risk to the user's personal safety for each event associated with a timer mode. For example, if the user creates a timer mode for an event with an inherently high level of risk attached, then the user can indicate that the timer mode is associated with a high risk activity. In some embodiments, at step 302, the user creates a timer mode that counts down a predetermined time period (e.g. 3 minutes, 10 minutes, 20 minutes, etc.) during an unexpected moment when the user senses danger. FIGS. 27 and 28 show example screenshots of mobile application 100 respectively displaying the creation of a timer mode and the counting down of the timer mode created in FIG. 27.

At step 304, the user assigns one or more emergency contacts/personnel and/or groups of emergency contact(s)/personnel to each timer mode. FIG. 14 shows an example screenshot of mobile application 100 allowing a user to assign emergency contact(s)/personnel to a timer mode. The emergency contact(s) and/or emergency personnel are contacted if an emergency mode is activated. During the emergency mode, system server 30 communicates with the emergency contact(s) and/or emergency personnel via device(s) 40 and/or 50 (as described elsewhere herein). System server 30 may transmit the user's personal information provided at step 202 and/or the user's personal safety data (described elsewhere herein) to the emergency contact(s) and/or the emergency personnel via device(s) 40 and/or 50. In some embodiments, mobile application 100 requires the user to select a minimum number of contacts at step 304 (e.g. three emergency contacts and/or emergency personnel). In some embodiments, at step 304, the user may rank the emergency contact(s)/personnel/group(s) according to the order that the user prefers that each emergency contact/personnel/group be communicated with on activation as an emergency mode (as described elsewhere herein with respect to step 212).

At optional step 306, mobile application 100 communicates with the one or more emergency contacts (via electronic device 40) and/or the emergency personnel (via electronic device 50) via system server 30 and requests that the emergency contact(s)/personnel agree to communicate mobile application 100 on activation of an emergency mode. If the one or more emergency contacts and/or emergency personnel do not agree at step 306, then the user returns to step 304. In some embodiments, mobile application 100 requires a minimum number of emergency contacts and/or emergency personnel to agree to communicate with mobile application 100 at step 306 (e.g. three emergency contacts). The emergency contact(s)/emergency personnel may provide additional or alternative account or profile information at step 306.

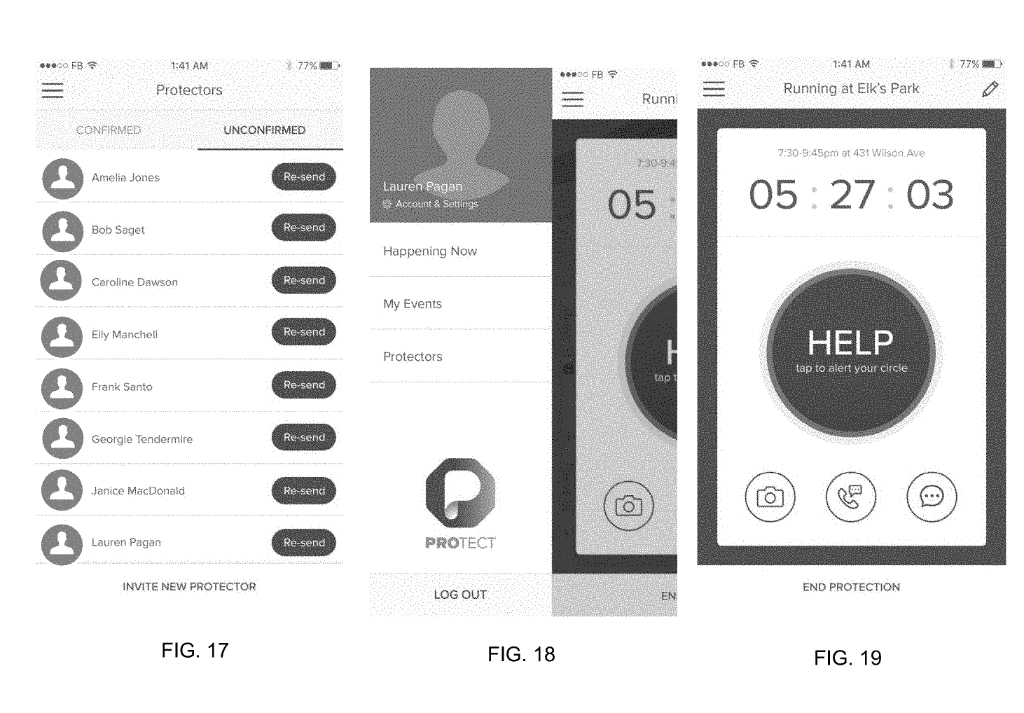

FIG. 16 shows an example screenshot of mobile application 100 showing a user's emergency contacts and/or emergency personnel that have agreed to communicate with mobile application 100 via device(s) 40 and/or 50. FIG. 17 shows an example screenshot of mobile application 100 showing the emergency contacts and/or emergency personnel that have not agreed to communicate with mobile application 100. In some embodiments, the user may prompt mobile application 100 to re-send a request to emergency contacts and/or emergency personnel to agree to communicate with mobile application 100 (FIG. 17). Emergency contacts and/or emergency personnel may be deleted by the user at any time (FIG. 16). Once deleted, mobile application 100 will not communicate with the emergency contact/personnel.

FIG. 18 shows an example screenshot of mobile application 100 showing tabs for a user's active timer mode(s) (“Happening Now”), upcoming timer mode(s) (“My Events”), and emergency contacts(s) and/or emergency personnel (“Protectors”). The user may log out of the user's account and/or profile created at step 202 at this screen.

At step 308, mobile application 100 automatically activates a timer mode at the start time of the timer mode entered at step 302. Once activated, the timer mode counts down to the timer mode's end time entered at step 302. For example, a timer mode created at step 302 to start at March 22 at 5:00 PM and end at March 22 at 8:00 PM is activated at step 308 at 5:00 PM on March 22 and counts down to 8:00 PM on March 22. FIG. 19 shows an example screenshot of mobile application 100 showing the countdown of a timer mode. As described elsewhere herein, an emergency mode is activated if the timer mode ends and the user has not dismissed the time mode. In some embodiments, the user can view the timer mode counting down on the user's electronic device (e.g. inside mobile application 100, etc.). In some embodiments, during an activated timer mode, mobile application 100 collects the user's personal safety data, including, but not limited to, one or more of the following: (i) the GPS coordinates 150 of the user's electronic device 20; (ii) audio data 160; (iii) one or more digital images 170; and (iv) video data 180, as described elsewhere herein. As described elsewhere herein, mobile application 100 may interface with a database, stored locally and/or on a remote server, that is configured to store the user's personal safety data. In some embodiments, the user's personal safety data is automatically deleted from the database. For example, if an emergency mode is not activated or the user deactivates an emergency mode, then the user's personal safety data may be automatically deleted from the database.

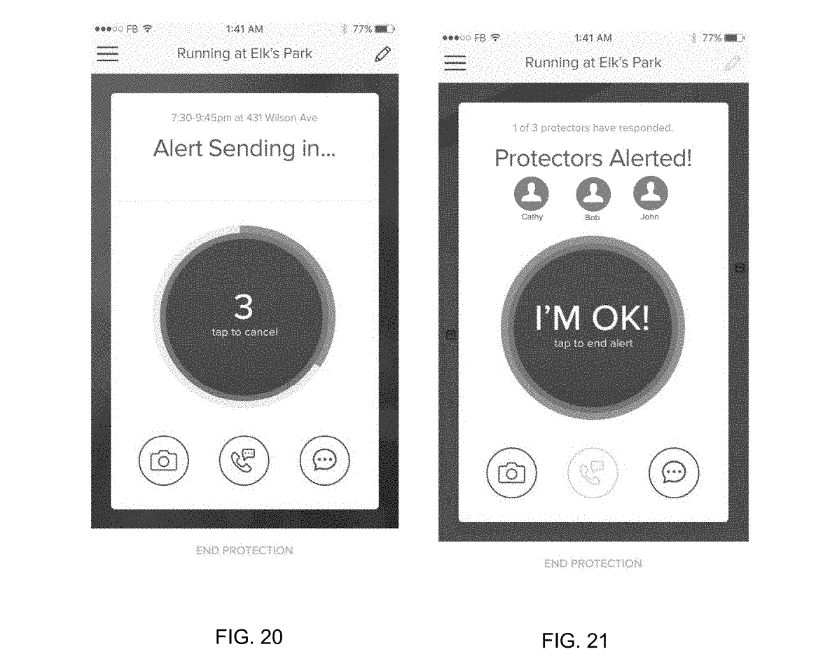

At optional step 310, mobile application 100 notifies the user that the timer mode will soon end and an emergency mode will soon be activated. In some embodiments, at step 310, mobile application 100 sends a notification (e.g. a push notification, etc.) to the user at a predetermined amount of time prior to the end time of the timer mode activated at step 308. For example, mobile application 100 may send a notification to the user 5 minutes before the end time of the timer mode activated at step 308, FIG. 20 shows an example screenshot of mobile application 100 showing a notification communicating an amount of time to a user until an emergency mode is activated. At step 312, the user may dismiss, ignore, or respond to the notification. For example, in some embodiments, the notification allows the user to respond and delay the end time of the timer mode by an amount of time. In some embodiments, the user can respond to the notification to extend the timer mode by entering a personal identification key. In some embodiments, the user can dismiss the notification to end the timer mode without activating an emergency mode by entering a personal identification key. In some embodiments, the personal identification key to dismiss the notification to end the timer mode and to respond to the notification to delay the timer mode are different. If the user ignores the notification, then an emergency mode is automatically activated at step 316 at the end time of the timer mode. In some embodiments, at step 310, mobile application 100 emits an audible signal and/or a visual signal (e.g. a light) to the user at an amount of time prior to the end time of the timer mode activated at step 308. In some embodiments, at step 310, mobile application 100 sends the user a “fake” message. The fake message requests the user's status without revealing that the user is engaging with mobile application 100. For example, the fake message may alert the user that a fake event (e.g. a doctor's appointment) is scheduled to occur. The user can engage with the fake message to activate an emergency mode or to dismiss the fake message if no assistance is required.

At step 314, the user can end a timer mode activated at step 308. The user may end a timer mode at step 314 by entering a personal identification key (described elsewhere herein) and/or cancelling a timer mode from inside mobile application 100. Once the user has ended the timer mode at step 314, an emergency mode cannot be automatically activated by mobile application 100 for that timer mode. The FIG. 19 screenshot shows a timer mode counting down. In some embodiments, a user may end the timer mode and/or activate an emergency mode at this screen.

At step 316, mobile application 100 enters an emergency mode. In some embodiments, mobile application 100 enters an emergency mode when the timer mode activated at step 308 has ended (i.e. after the expiry of the end time of the timer mode). In some embodiments, mobile application 100 enters an emergency mode when the user manually activates an emergency mode. The user may manually activate an emergency mode at step 316 at any time. For example, the user may activate an emergency mode by pressing a button inside mobile application 100, pressing a button on the home screen of the user's electronic device, or entering a personal identification key (as described elsewhere herein). In an emergency mode, mobile application 100 collects the user's personal safety data, including, but not limited to, one or more of the following: (i) GPS coordinates 150 of the user's electronic device 20; (ii) audio data 160; (iii) one or more digital images 170; and (iv) video data 180, as described elsewhere herein. In some embodiments, mobile application 100 emits an audio alarm signal and/or a light or light pattern and/or vibrates at step 316. As described elsewhere herein, mobile application 100 may interface with a database, stored locally and/or on a remote server, that is configured to store the user's personal safety data. In some embodiments, at step 316, mobile application 100 periodically collects personal safety data following the activation of an emergency mode. For example, mobile application 100 may collect the user's personal safety data every 5 minutes following the activation of an emergency mode. In some embodiments, the user's electronic device records audio and/or one or more digital images and/or video whenever one or more of the following events occurs: (i) a “lock screen” of the user's electronic device is displayed during an emergency mode; (ii) an incorrect personal identification key is entered during an emergency mode; (iii) a timer mode is extended at step 312; and (iv) the user changes its status (e.g. the user changes its text status and/or the user engages with mobile application 100 and/or the user changes its status with mobile application 100). As described elsewhere herein, mobile application 100 may interface with a database, stored locally and/or on a remote server, that is configured to store the user's personal safety data. In some embodiments, the user's personal safety data is stored and/or automatically deleted from the database. For example, if the user deactivates an emergency mode, then the user's personal safety data is automatically deleted from the database.

At step 318, mobile application 100 communicates with the emergency contact(s)/personnel selected at step 304 and/or confirmed at step 306 using the account or profile information provided at step 204 and/or step 208. In some embodiments, the mobile application communicates with the emergency contact(s)/personnel at step 318 according to the order assigned by the user at step 212 and/or step 304. FIG. 21 shows an example screenshot of mobile application 100 notifying a user that the user's emergency contact(s) and/or emergency personnel have been communicated with. In some embodiments, at step 318, the emergency contact(s) and/or emergency personnel can respond to the communication from mobile application 100. As shown in FIG. 21, mobile application 100 may notify the user if and/or when an emergency contact/personnel has responded to a communication from mobile application 100.

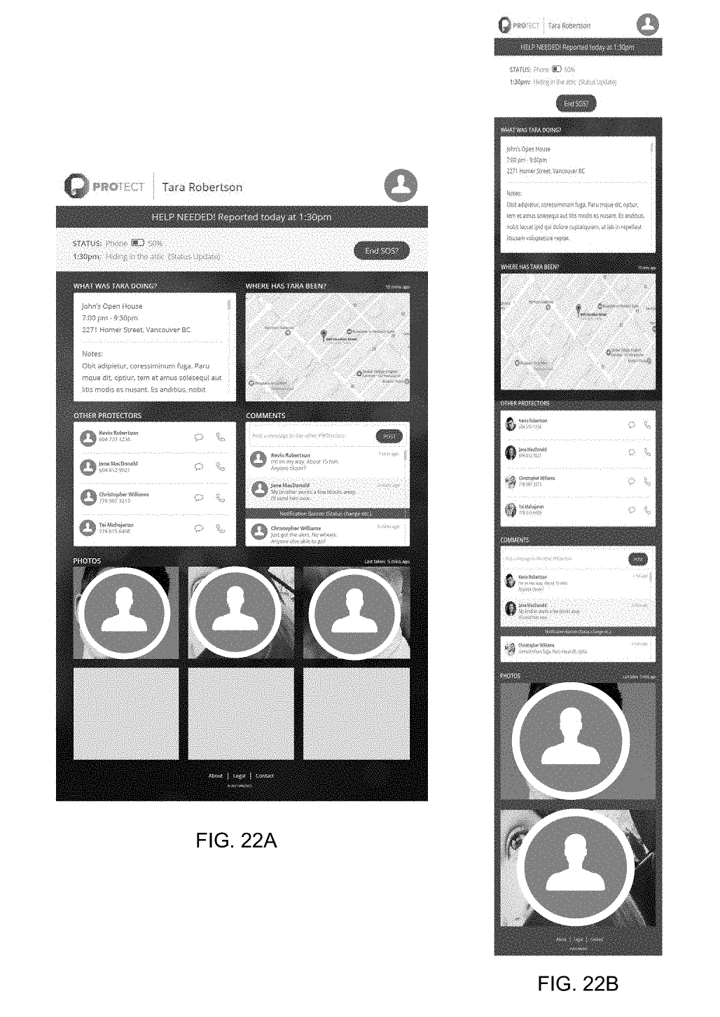

At step 318, mobile application 100 provides each emergency contact/personnel with the user's personal safety data collected at step 316. In some embodiments, at step 318, mobile application 100 provides each emergency contact/personnel with the user's personal information provided at step 202. In some embodiments, at step 318, mobile application 100 provides each emergency contact/personnel with a link to an activity portal (e.g. a webpage, etc.). The activity portal may display one or more of the following: (i) the user's personal safety data collected at step 316; (ii) the user's personal information provided at step 202; (iii) the account and/or profile information of each emergency contact(s)/personnel provided at step 204 and/or step 208; and (iv) the status of the user (i.e., the user's engagement with mobile application 100 during the emergency mode). In some embodiments, the emergency contact(s)/personnel may communicate with other emergency contact(s)/personnel using the activity portal. Mobile application 100 automatically uploads the user's personal safety data collected at step 316 to the activity portal. FIGS. 22A-22B show screenshots of an example activity portal. The activity portal displays the battery life of the user's electronic device 20, the user's status (e.g. the user's text status and/or the status provided by the user via mobile application 100), timer mode details (e.g. start time, end time, event location, event notes), the user's GPS location, the user's emergency contact(s)/personnel assigned to the timer mode, a comments board for the assigned emergency contact(s)/personnel to communicate with each another, and photographs of the user and/or the assigned emergency contact(s)/personnel).

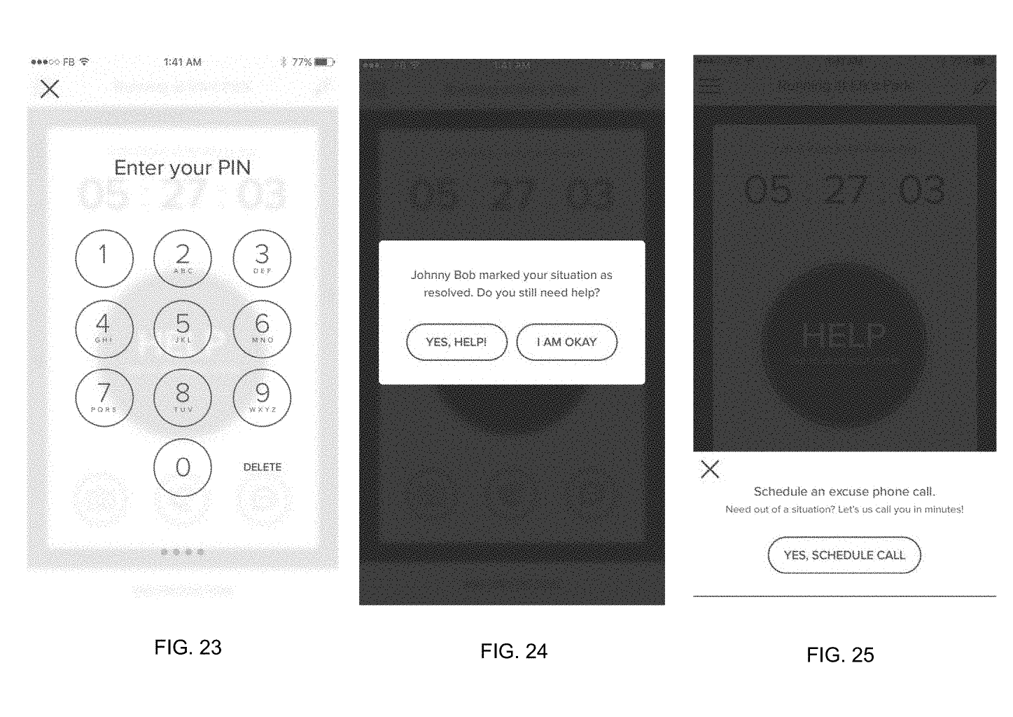

The user may deactivate an emergency mode at step 320. The user may deactivate an emergency mode at step 320 by entering a personal identification key (as described elsewhere herein) and/or by cancelling the emergency mode from inside mobile application 100. FIG. 23 shows an example screenshot of mobile application 100 prompting a user to enter a PIN to deactivate an emergency mode. In some embodiments, at step 320, the emergency contact(s)/personnel may deactivate an emergency mode by communicating with the user through mobile application 100 to confirm that the user is safe. The user may confirm safety by entering a personal identification key and/or by cancelling the emergency mode from inside mobile application 100. If the user does not confirm safety, then the emergency mode is not deactivated. FIG. 24 shows an example screenshot of mobile application 100 notifying a user that the user's emergency contact has indicated that the user's emergency mode should be deactivated and prompting the user to confirm that the emergency mode should be deactivated. The emergency mode is deactivated only if the user confirms that the emergency mode should be deactivated.

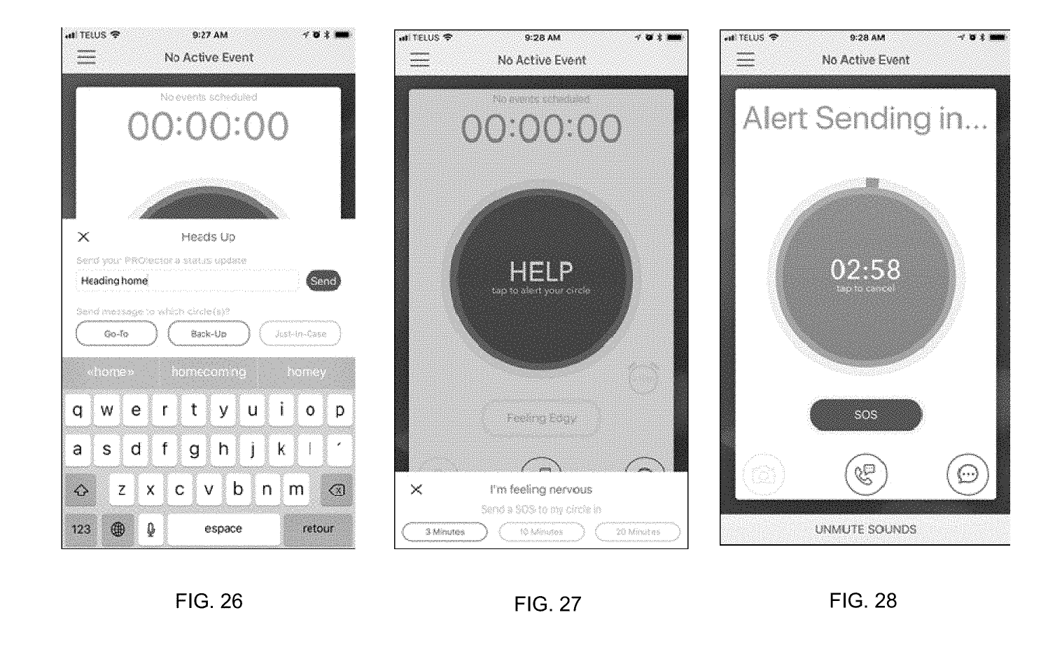

Mobile application 100 transmits a communication to electronic device(s) 40 and/or 50 operated by the emergency contact(s)/personnel assigned at step 304 and/or confirmed at step 306 in the event of any one or more of the following: (i) the user engages with mobile application 100 during an emergency mode; (ii) the user changes its status (e.g. the user changes its status and/or the user changes its status with mobile application 100) during an emergency mode; (iii) the user deactivates an emergency mode at step 320; (iv) the geographic location of the user's device changes during an emergency mode; (v) the user's electronic device records audio data during an emergency mode: (vi) the user's electronic device records one or more digital images during an emergency mode; (vii) the user's electronic device records video data during an emergency mode; (viii) the user extends a timer mode; and (ix) the user ends a timer mode. For example, FIG. 26 shows an example screenshot of mobile application 100 displaying the user updating its status.

In some embodiments, the user may schedule a “fake” telephone call at any time. The user schedules the “fake” call by entering a start time for the call. At the entered start time, mobile application 100 causes the user's electronic device to ring, thereby simulating a “fake” call. The “fake” call may be used by the user to disrupt an event with a third party and provide the user with an opportunity to end and/or leave the event, FIG. 25 shows an example screenshot of mobile application 100 prompting a user to schedule a “fake” call.

In some embodiments, mobile application 100 notifies the user whenever cellular and/or Internet connection is not available. In some embodiments, mobile application 100 sends the user a notification (e.g. a push notification, etc.) when cellular and/or Internet connectivity is lost.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

Those skilled in the art will recognize that the embodiments of the present invention involve both hardware and software elements which portions are described below in such detail required to construct and operate the method according to the embodiments of the present invention.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would further include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF, and the like, or any suitable combination of the foregoing.

Computer program code for carrying out operations for aspects of the present invention may be written in any combination of one or more programming languages, including an object oriented programming language such as Java, Smalltalk. C++, or the like or conventional procedural programming languages, such as the “C′” programming language, AJAX, PHP, HTML, XHTML, Ruby, CSS, or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer, or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus, and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus, or other devices to produce a computer-implemented process such that the instructions which execute on the computer or other programmable apparatus provide processes for implementing the functions/acts specified in the flowchart and/or block diagrams.

1. A method performed on an electronic device for overseeing the personal safety of a user, the method comprising:
creating a timer mode having a start time and an end time;
assigning an emergency contact to the timer mode;
at the start time of the timer mode, automatically activating the timer mode;
at the end time of the timer mode, automatically activating an emergency mode; and
communicating the user's personal safety data with the emergency contact during the emergency mode.

2. A method according to claim 1, wherein creating the timer mode comprises importing a calendar event stored locally on the electronic device and/or on a remote server and/or on the user's social media or other communication platform.

3. A method according to claim 1, wherein assigning an emergency contact to the timer mode comprises importing contact information of the emergency contact stored locally on the electronic device and/or on a remote server and/or on the user's social media or other communication platform.

4. A method according to claim 1, wherein assigning an emergency contact to the timer mode comprises assigning a predetermined number of emergency contacts to the timer mode.

5. A method according to claim 1, wherein assigning the emergency contact to the timer mode comprises assigning one or more emergency contacts to a group and assigning the group to the timer mode.

6. A method according to claim 1, wherein the emergency mode is automatically activated only if the user has not dismissed or delayed the end time.

7. A method according to claim 1, further comprising entering a first user identification key to deactivate the emergency mode.

8. A method according to claim 7, further comprising entering a second user identification key to activate the emergency mode.

9. A method according to claim 7, wherein the first user identification key comprises a personal identification number, a biometric, a password, or a correct answer to a personal security question.

10. A method according to claim 9, wherein the biometric comprises a fingerprint.

11. A method according to claim 8, wherein the second user identification key comprises a personal identification number, a biometric, a password, or a correct answer to a personal security question.

12. A method according to claim 11, wherein the biometric comprises a fingerprint.

13. A method according to claim 1, further comprising recording one or more of GPS data, audio data, video data, and a digital image at one or more predetermined time intervals on activation of the emergency mode.

14. A method according to claim 1, wherein the user's personal safety data comprises one or more of: GPS data, audio data, video data, and a digital image.

15. A method according to claim 1, further comprising deactivating the timer mode, wherein deactivating the timer mode avoids communicating the user's personal safety data to the emergency contact.

16. A method according to claim 1, wherein communicating the user's personal safety data to the emergency contact comprises providing the emergency contact with access to an activity portal.

17. A method according to claim 16, wherein the activity portal comprises a webpage including the user's personal safety data.

18. A method according to claim 16, wherein the activity portal comprises a webpage including the contact information of the emergency contact.

19. A method according to claim 16, wherein the emergency contact can communicate with other emergency contacts via the activity portal.

20. A method according to claim 1, further comprising recording one or more of GPS data, audio data, video data, and a digital image when an incorrect personal identification key is entered during the emergency mode and/or the timer mode.
